(19) United States
(12) Patent Application Publication
(10) Pub. No.: US 2004/0098540 A1
(43) Pub. Date: May 20, 2004

(54) Cache system and cache memory control device controlling cache memory having two access modes

(75) Inventors: Teruyuki Itoh, Hyogo (JP); Naoto Okumura, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/610,763

(22) Filed: Jul. 2, 2003

(30) Foreign Application Priority Data
Nov. 19, 2002 (JP) 2002-334768(P)

(51) Int. Cl. G06F 13/00; G06F 12/00

(52) U.S. Cl. 711/118; 713/323; 711/140

(57) ABSTRACT

A branch/prefetch judgement portion, in receipt of a branch request signal, sets a cache access mode switch signal to an “H” level. Thus, a cache memory operates in the 1-cycle access mode consuming a large amount of power. In receipt of a prefetch request signal, the branch/prefetch judgement portion sets the cache access mode switch signal to an “L” level. Thus, the cache memory operates in the 2-cycle access mode consuming less power.

### BACKGROUND OF THE INVENTION

1. Field of the Invention

The present invention relates to cache systems and cache memory control devices, and more particularly to a cache system and a cache memory control device which control a cache memory having two access modes: an access mode in which it operates at high speed consuming a large amount of power, and an access mode in which it operates at low speed consuming less power.

2. Description of the Background Art

A cache system employing a cache memory has conventionally been put into practical use to compensate for an access speed of a main memory. The cache memory is a fast recording medium placed between a processor and the main memory, which stores frequently used data. The processor can access the cache memory, instead of the main memory, to obtain the data for high-speed processing.

Japanese Patent Laying-Open No. 11-39216 discloses a cache memory having two access modes: a full access mode and a unique access mode. In the full access mode, an indexing operation is performed on all the ways, parallel to a hit/miss judgement operation in an address memory within the cache memory. This accelerates an external output of the data according to the cache hit. In the unique access mode, the indexing operation is performed on a way selected by a way select signal that is obtained from the hit/miss judgement operation in the address memory within the cache memory. In this mode, only a minimal amount of memory regions operates, leading to less power consumption.

According to Japanese Patent Laying-Open No. 11-39216, selection of the full access mode or the unique access mode is made only in the case of burst access such as consecutive reading. That is, it is described that the full access mode is selected for the first access, and the unique access mode is selected for the succeeding accesses in the burst access for consecutive reading.

Such selection between the two access modes, however, is required not only in the case as described above.

For example, in a cache system performing pipeline processing of a plurality of data items, it is desired to prevent pipeline stall (waiting for process execution) or, when the stall occurs, to make the waiting time as short as possible. On the other hand, if the pipeline stall does not occur, the cache system is desired to operate consuming the least possible power.

Further, in a cache system provided with a central processing unit (CPU) which operates by selecting one of at least two kinds of clock frequencies, a high-speed operation is given higher priority than low power consumption when a high clock frequency is selected, whereas the low power consumption is given higher priority than the high-speed operation when a low clock frequency is selected.

### SUMMARY OF THE INVENTION

An object of the present invention is to provide a cache system which can select, when a CPU performs pipeline processing of a plurality of instructions, an appropriate access mode where an operation consuming the least possible power is ensured while the pipeline stall waiting for the processing is prevented or such a process waiting time is reduced.

Another object of the present invention is to provide a cache memory control device which can select, when a CPU operating by selecting one of at least two kinds of clock frequencies is used, an appropriate access mode in accordance with the clock frequency currently selected by the CPU.

The cache system according to an aspect of the present invention is provided with a cache memory which performs an operation to output stored data as accessed, during a first time period in a first access mode, and during a second time period that is longer than the first time period in a second access mode, a processor which performs pipeline processing of the data within the cache memory, and an access mode control portion which outputs, to the cache memory, one of a first access mode signal designating to operate in the first access mode and a second access mode signal designating to operate in the second access mode, based on presence/absence of pipeline stall in respective one of the access modes.

Accordingly, it is possible to select an appropriate access mode ensuring an operation with the least possible power consumption, while the pipeline stall waiting for the processing is prevented or such a wait time is reduced.

The cache memory control device according to another aspect of the present invention controls a cache memory which performs an operation to output stored data as accessed during a first time period in a first access mode and during a second time period that is longer than the first time period in a second access mode. The cache memory control device includes an access mode control portion which outputs a signal designating the first access mode in the case where a processor, processing data within the cache memory by selecting and operating at one of a plurality of clock frequencies, is operating at a clock frequency of not lower than a prescribed value, and outputs a signal designating the second access mode in the case where the processor is operating at a clock frequency of less than the prescribed value.

Accordingly, an appropriate access mode can be selected according to the clock frequency currently selected for the processor.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a cache memory according to a first embodiment of the present invention.

FIG. 2 shows a detailed configuration of a cache access mode switch portion 9.

FIG. 3 is a timing chart showing an operation of the cache memory 100 in a 2-cycle access mode.

FIG. 4 is a timing chart showing an operation of cache memory 100 in a 1-cycle access mode.

FIG. 5 shows a configuration of a cache system according to the first embodiment.

FIG. 6 shows procedure of reading and executing instructions within cache memory 100 in an ordinary operation other than branch and prefetch operations.

FIG. 7 shows procedure of reading and executing instructions within cache memory 100 in the branch operation.

FIG. 8 shows procedure of reading and executing instructions within cache memory 100 in the prefetch operation.

FIG. 9 shows a configuration of a cache system according to a second embodiment of the present invention.

FIG. 10 shows procedure of reading and executing instructions within cache memory 100 at the time when a branch destination address has lower two bits of “HH”.

FIG. 11 shows transitions in state of the instruction queue 18.

FIG. 12 shows a configuration of a cache system according to a third embodiment of the present invention.

FIG. 13 shows procedure of reading and executing instructions and operand data within cache memory 100 at the time when register numbers match.

FIG. 14 shows procedure of reading and executing instructions and operand data within cache memory 100 at the time when the register numbers mismatch.

FIG. 15 shows a configuration of a cache system according to a fourth embodiment of the present invention.

FIG. 16 shows procedure of reading and executing instructions within the instruction cache memory 98 at the time when a high clock frequency is selected in the CPU.

FIG. 17 shows procedure of reading and executing instructions within instruction cache memory 98 and operand data within the data cache memory 99 at the time when a high clock frequency is selected in the CPU.

FIG. 18 shows procedure of reading and executing instructions within instruction cache memory 98 at the time when a low clock frequency is selected in the CPU.

FIG. 19 shows procedure of reading and executing instructions within instruction cache memory 98 and operand data within data cache memory 99 at the time when a low clock frequency is selected in the CPU.

FIGS. 20 and 21 show modifications of the procedure of reading and executing instructions within cache memory 100 at the time when a branch destination address has lower two bits of “HH”.

### DESCRIPTION OF THE PREFERRED EMBODIMENTS

Hereinafter, embodiments of the present invention will be described with reference to the drawings.

### First Embodiment

(Configuration)

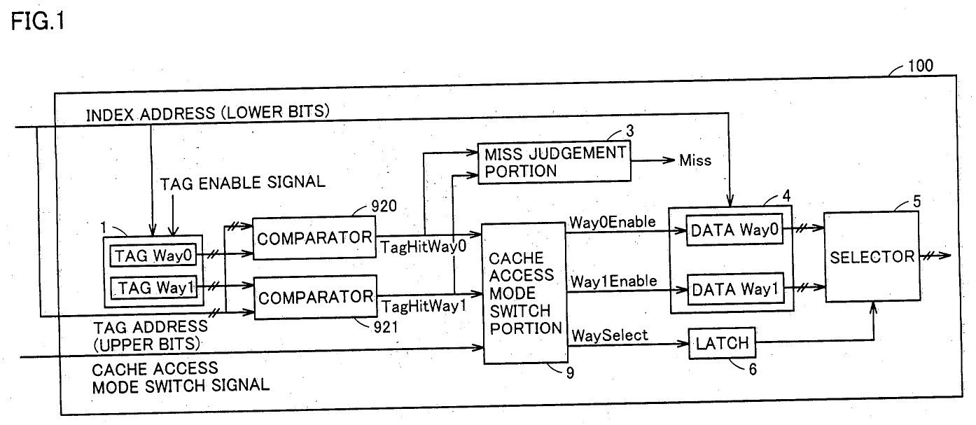

The cache memory 100 according to the first embodiment shown in FIG. 1 is of a 2-way set associative type. Referring to FIG. 1, cache memory 100 is configured with a TAG memory 1, comparators 920, 921, a miss judgement device 3, a cache access mode switch portion 9, a DATA memory 4, a latch circuit 6, and a selector 5.

TAG memory 1 is an address memory, which includes two address arrays: tag Way0 and tag Way1. Tag Way0 and tag Way1 store tag addresses correlated with index addresses.

The tag address specified by the index address in tag Way0 indicates an upper address of data specified by the same index address in data Way0 as will be described later. Similarly, the tag address specified by the index in tag Way1 indicates an upper address of data specified by the same index in data Way1.

Tag Way0 and tag Way1 each receive an index address being the lower address of the designated address, and output a tag address corresponding to the index address.

A tag enable signal is input to tag Way0 and tag Way1. Tag Way0 and tag Way1 operate when the tag enable signal is at an “H” level, and do not operate when it is at an “L” level.

Comparator 920 compares the tag address output from tag Way0 with a tag address being the upper address of the designated address. When they match, comparator 920 sets TagHitWay0 to an “H” level to indicate a cache hit, or, that there exists data for the designated address in data Way0. When they mismatch, comparator 920 sets TagHitWay0 to an “L” level to indicate that there is no data of the designated address in data Way0, i.e., a cache miss.

Comparator 921 compares the tag address output from tag Way1 with a tag address being the upper address of the designated address. When they match, it sets TagHitWay1 to an “H” level to indicate that data of the designated address exists in data Way1, i.e., a cache hit. When they mismatch, it sets TagHitWay1 to an “L” level to indicate that such data of the designated address does not exist in data Way1, i.e., a cache miss.

Miss judgement device 3, when TagHitWay0=“L” and TagHitWay1=“L”, outputs a Miss signal to CPU 120 indicating that data for the designated address does not exist in data Way0 or data Way1. CPU 120, in receipt of the Miss signal, handles the data output from cache memory 100 as invalid data.

DATA memory 4 includes two data arrays: data Way0 and data Way 1. Data Way0 and data Way1 store data correlated with index addresses. Here, data refers to instructions or operand data. Hereinafter, the term “data” may represent both the instructions and the operand data.

Data stored in data Way0 has a corresponding index address as a lower address and a tag address stored corresponding to the same index address in tag Way0 as an upper address.

Similarly, data stored in data Way1 has a corresponding index address as a lower address and a tag address stored corresponding to the same index address within tag Way1 as an upper address.

Data Way0 and data Way1 each receive an index address.

When Way0Enable output from cache access mode switch portion 9 is at an “H” level, data Way0 outputs data corresponding to the input index address to selector 5. Data Way0 does not operate when Way0Enable is at an “L” level.

When Way1Enable output from cache access mode switch portion 9 is at an “H” level, data Way1 outputs data corresponding to the input index address to selector 5. Data Way1 does not operate when Way1Enable is at an “L” level.

Cache access mode switch portion 9 is externally supplied with a cache access mode switch signal. When the cache access mode switch signal is at an “H” level, cache memory 100 operates in the 1-cycle access mode, whereas it operates in the 2-cycle access mode when the cache access mode switch signal is at an “L” level.

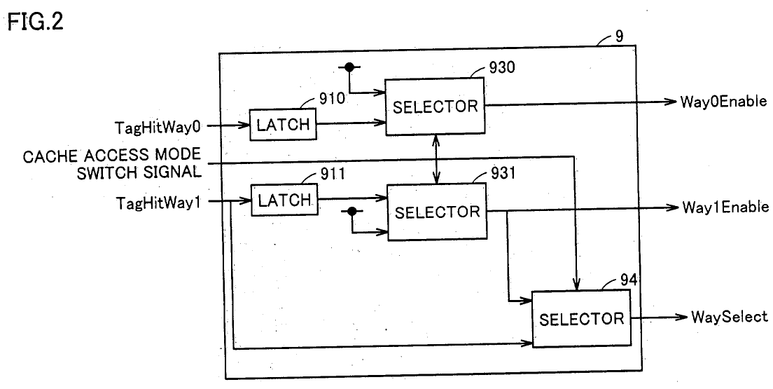

Referring to FIG. 2, cache access mode switch portion 9 includes latches 910, 911, and selectors 930, 931, 94.

Latch circuit 910 receives TagHitWay0 output from comparator 920 and outputs the same after a delay of a ½ cycle period.

Latch circuit 911 receives TagHitWay1 output from latch circuit 921 and outputs the same after a delay of a ½ cycle period.

Selector 930 outputs a signal of an “H” level as Wa0Enable when the cache access mode switch signal is at an “H” level.

When the cache access mode switch signal is at an “L” level, selector 930 outputs, as Way0Enable, the signal output from latch circuit 910, i.e., TagHitWay0 output from comparator 920 and delayed by a ½ cycle period. This causes data Way0 to operate one cycle behind the cycle at which TAG memory 1 operates.

When the cache access mode switch signal is at an “H” level, selector 931 outputs a signal of an “H” level as Way1Enable.

When the cache access mode switch signal is at an “L” level, selector 931 outputs, as Way1Enable, the signal output from latch circuit 911, i.e., TagHitWay1 output from comparator 921 and delayed by a ½ cycle period. As such, data Way1 comes to operate one cycle behind the cycle where TAG memory 1 operates.

As described above, in the 2-cycle access mode, selectors 930 and 931 function to make TAG memory 1 operate (as accessed) one cycle ahead of the cycle at which DATA memory 4 operates (as accessed). Thus, data is output from cache memory 100 in two cycles. On the other hand, in the 1-cycle access mode, TAG memory 1 is made to operate (as accessed) a ½ cycle ahead of the cycle at which DATA memory 4 operates (as accessed). Thus, data is output from cache memory 100 in one cycle.

Selector 94 outputs Way1Enable as WaySelect when the cache access mode switch signal is at an “L” level. This is because, when data Way1 is selected with the cache access mode switch signal being at an “L” level, Way1Enable attains an “H” level a ½ cycle behind the access cycle to TAG memory 1, i.e., a ½ cycle ahead of the access cycle to DATA memory 4.

When the cache access mode switch signal is at an “H” level, selector 94 outputs TagHitWay1 as WaySelect. This is because, when data Way1 is selected while the cache access mode switch signal is at an “H” level, TagHitWay1 attains an “H” level at the access cycle to DATA memory 4, i.e., the same cycle as the access cycle to TAG memory 1.

Latch 6 holds WaySelect output from selector 94.

When the signal output from latch 6 is at an “L” level, selector 5 outputs the data output from data Way0. When the signal from latch 6 is at an “H” level, it outputs the data output from data Way1.

(Operation in 2-Cycle Access Mode)

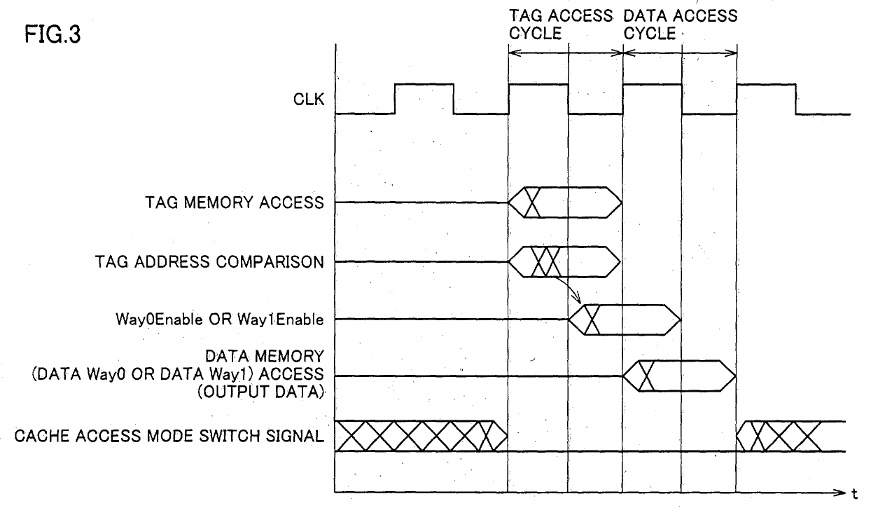

Now, the operation of cache memory 100 in the 2-cycle access mode will be described with reference to the timing chart shown in FIG. 3.

Referring to FIG. 3, in the 2-cycle access mode, cache memory 100 outputs data in two cycles of a TAG access cycle and a DATA access cycle.

Firstly, at the first half of the TAG access cycle, TAG memory 1 is accessed and tag addresses are output from respective tags Way0 and Way1.

Comparator 920 compares the tag address output from tag Way0 with an externally designated tag address. When they match, it sets TagHitWay0 to “H”, while it sets TagHitWay0 to “L” when they mismatch. Comparator 921 compares the tag address output from tag Way1 with an externally designated tag address. It sets TagHitWay1 to “H” when they match, and sets it to “L” when they mismatch. Thus, in the case where data of the designated address exists in the cache memory (DATA memory 4), either one of TagHitWay0 and TagHitWay1 is set to “H”, while both of TagHitWay0 and TagHitWay1 are set to “L” when data of the designated address does not exist.

Next, at the second half of the TAG access cycle, Way0Enable is set to “H” when TagHitWay0=“H”, while Way1Enable is set to “H” when TagHitWay1=“H”.

Next, at the first half of the DATA access cycle, data Way0 is accessed to output data when Way0Enable=“H”. When Way1Enable=“H”, data Way1 is accessed to output data.

Thus, in the 2-cycle access mode, the TAG memory is accessed at the first cycle, and the DATA memory is accessed at the second cycle. In this case, either one of data Way0 and data Way1 operates, while the other does not operate, resulting in low power consumption.

(Operation in 1-Cycle Access Mode)

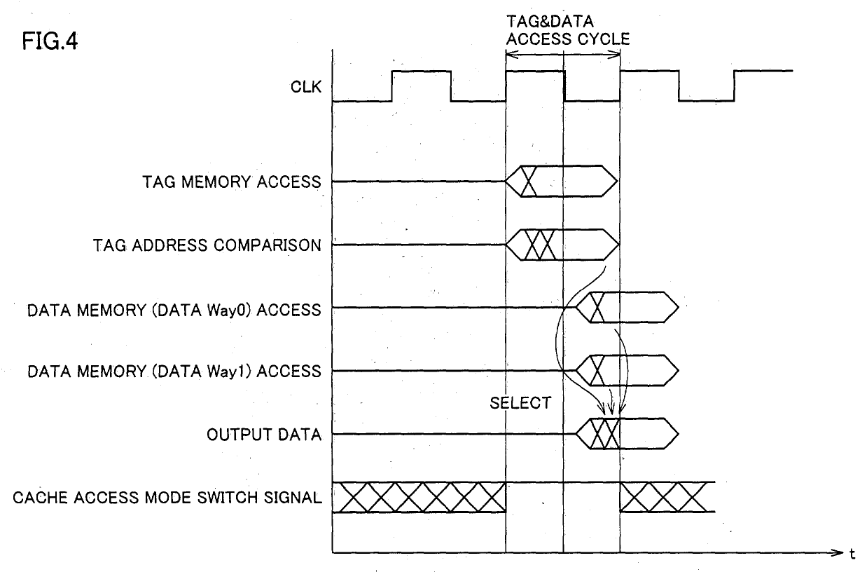

Now, the operation of cache memory 100 in the 1-cycle access mode will be described with reference to the timing chart shown in FIG. 4.

Referring to FIG. 4, in the 1-cycle access mode, data is output from cache memory 100 in a TAG&DATA access cycle of one cycle.

Firstly, at the first half of the TAG&DATA access cycle, TAG memory 1 is accessed and tag addresses are output from respective tags Way0 and Way1.

Comparator 920 compares the tag address output from tag Way0 with an externally designated tag address. When they match, it sets TagHitWay0 to “H”, while it sets TagHitWay0 to “L” when they mismatch. Comparator 921 compares the tag address output from tag Way1 with an externally designated tag address. It sets TagHitWay1 to “H” when they match, and sets TagHitWay1 to “L” when they mismatch. Thus, in the case where data of the designated address exists in the cache memory (DATA memory 4), either one of TagHitWay0 and TagHitWay1 is set to “H”, whereas both TagHitWay0 and TagHitWay1 are set to “L” when such data of the designated address does not exist.

In parallel with the above-described processing by comparators 920 and 921, Way0Enable is set to “H” and Way1Enable is set to “H” at the same cycle.

Next, at the second half of the TAG&DATA access cycle, data Way0 and data Way1 are accessed to output data.

Selector 5 selects data output from data Way0 or data Way1 in accordance with a value of WaySelect that is determined by the value of TagHitWay1.

As such, in the 1-cycle access mode, the TAG memory access and the DATA memory access are performed in one cycle. In this case, power consumption increases as data Way0 and data Way1 operate simultaneously.

Now, a cache system employing such a cache memory is described.

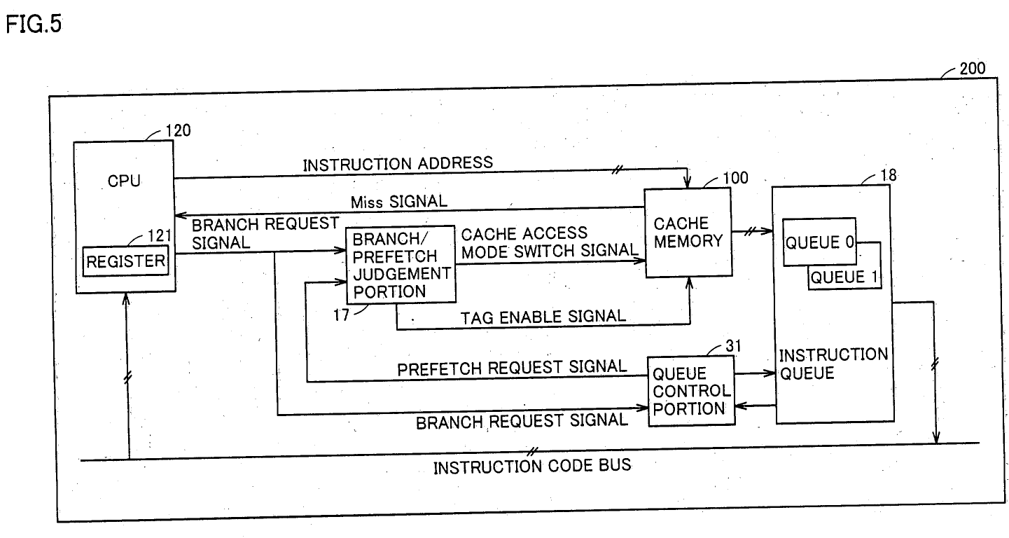

The cache system 200 shown in FIG. 5 includes a cache memory 100, a CPU (processor) 120, an instruction queue 18, a queue control portion 31, and a branch/prefetch judgement portion 17.

This cache system 200 adopts the pipeline processing where a plurality of instructions are executed simultaneously.

Cache memory 100 is as shown in FIG. 1. In cache memory 100, the TAG memory access and the DATA memory access are conducted with respect to data (instructions) designated by instruction addresses at the IF1 stage of the pipeline, and instructions are output from cache memory 100. This IF1 stage lasts for two cycles in the 2-cycle access mode and one cycle in the 1-cycle access mode. Cache memory 100 simultaneously outputs four instructions having a common upper address, excluding two lower bits, of the instruction addresses externally input.

Instruction queue 18 consists of a queue 0 and a queue 1. In each queue, the instructions output from cache memory 100 are written at the IF2 stage (first one of the two cycles) of the pipeline.

Each queue holds at most four instructions. In each queue, four instructions are simultaneously transmitted from cache memory 100 after the last instruction within the queue is output. Each queue stores instructions having “LL”, “LH”, “HL”, “HH” as the lower addresses of two bits, from the leading position, in this order.

When the last instruction in a queue is output to CPU 120, an instruction is output from another queue to CPU 120. That is, queue 1 outputs an instruction after queue 0 outputs the last instruction. When the last instruction is output from queue 1, an instruction is output from queue 0. In general, the instructions in the respective queues are output sequentially from the leading position. That is, the instructions having the lower addresses of two bits of “LL”, “LH”, “HL”, and “HH” are output in this order. Accordingly, the instruction having the lower address of two bits of “LL” is called the first instruction, the one having the lower address of “LH” the second instruction, the one with “HL” the third instruction, and the one with “HH” the last instruction. After execution of a branch instruction, an instruction designated by the branch destination address is output from a queue, irrelevant to the above-described order.

Queue control portion 31 controls the output of instructions held in the respective queues in instruction queue 18. When the last instruction in a queue is output, queue control portion 31 outputs a prefetch request signal to branch/prefetch judgement portion 17.

Queue control portion 31, in receipt of the branch request signal, flushes (erases) the instructions held in every queue in instruction queue 18.

CPU (processor) 120 performs the pipeline processing of instructions. That is, CPU 120 reads an instruction out of a queue at the IF2 stage (the second one of the two cycles), decodes the instruction at the DEC stage, executes the instruction at the Exe stage, and stores the execution result to a register at the WB stage. This WB stage is eliminated for an instruction, e.g., a branch instruction, of which execution result is unnecessary to be stored in the register.

After execution of the branch instruction, CPU 120 outputs a branch request signal to branch/prefetch judgement portion 17 and to queue control portion 31.

Further, after execution of the branch instruction, CPU 120 flushes the pipeline. That is, CPU 120 handles the instructions succeeding the branch instruction and having been processed as if they were not processed at all.

Branch/prefetch judgement portion 17, when not receiving the branch request signal or the prefetch request signal, sets the tag enable signal to an “L” level and the cache access mode switch signal to an “L” level. In this case, neither TAG memory 1 nor DATA memory 4 in cache memory 100 operates.

In receipt of the branch request signal, branch/prefetch judgement portion 17 sets the tag enable signal to an “H” level, and sets the cache access mode switch signal to an “H” level. In this case, cache memory 100 operates in the 1-cycle access mode, and an instruction is output from cache memory 100 in one cycle. After execution of the branch instruction, the pipeline and every queue in instruction queue 18 are flushed. Thus, outputting the instruction in one cycle can reduce the wait time after the execution of the branch instruction before a next instruction is executed.

Upon receipt of the prefetch request signal, branch/prefetch judgement portion 17 sets the tag enable signal to an “H” level and the cache access mode switch signal to an “L” level. In this case, cache memory 100 operates in the 2-cycle access mode, and an instruction is output from cache memory 100 in two cycles. This is because, even if one queue becomes empty, the other queue stores four instructions. That is, while an instruction is being output to the empty queue in two cycles, four instructions are processed in the other queue, preventing occurrence of the pipeline stall.

(Ordinary Operation)

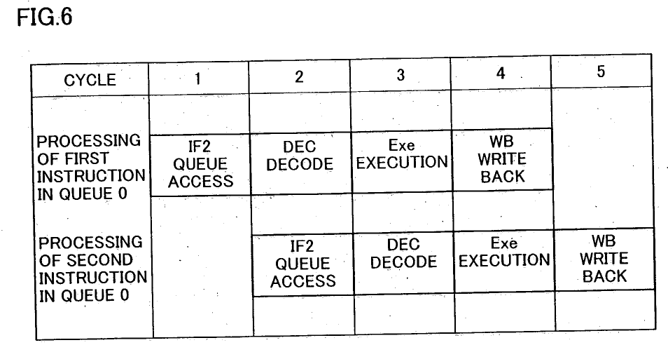

FIG. 6 shows procedure of reading and executing instructions within cache memory 100 in an ordinary operation other than the branch and prefetch operations. Referring to FIG. 6, a queue access is performed to read an instruction at the first cycle, the instruction is decoded at the second cycle, the instruction is executed at the third cycle, and the execution result of the instruction is written into a register inside the CPU at the fourth cycle. The above-described pipeline processing is performed on a plurality of instructions at the same time, with one cycle offset for each instruction.

(Branch Operation)

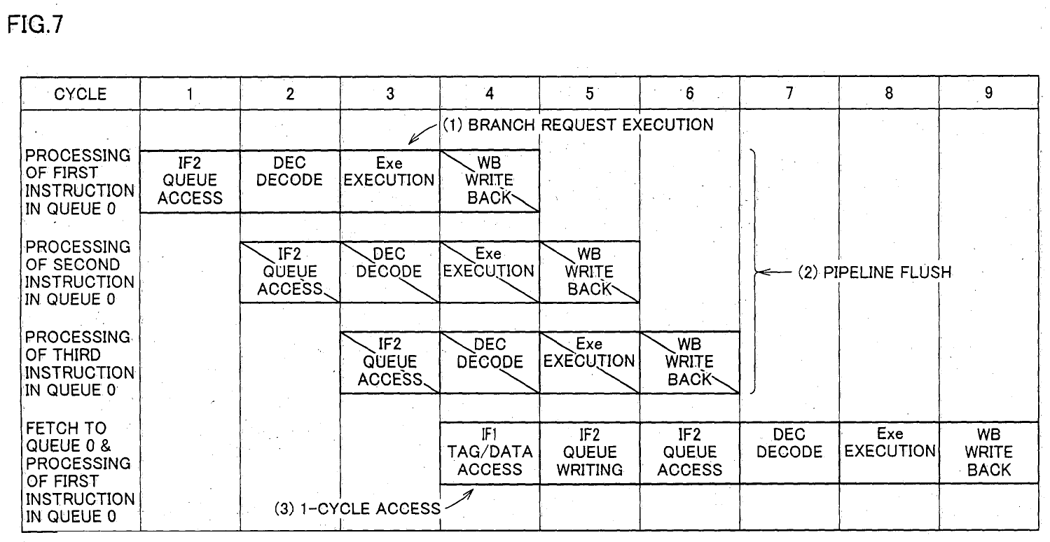

FIG. 7 shows procedure of reading and executing instructions within cache memory 100 in the branch operation. Referring to FIG. 7, after a branch instruction is executed in CPU 120 as shown in (1), the pipeline is flushed as shown in (2), and, at the same time, instruction queue 18 is flushed. Thereafter, a branch request signal is output from CPU 120 to branch/prefetch judgement portion 17. Branch/prefetch judgement portion 17 sets the tag enable signal to an “H” level and the cache access mode switch signal to an “H” level. Thus, as shown in (3), cache memory 100 operates in the 1-cycle access mode, and an instruction is output from cache memory 100 in one cycle.

(Prefetch Operation)

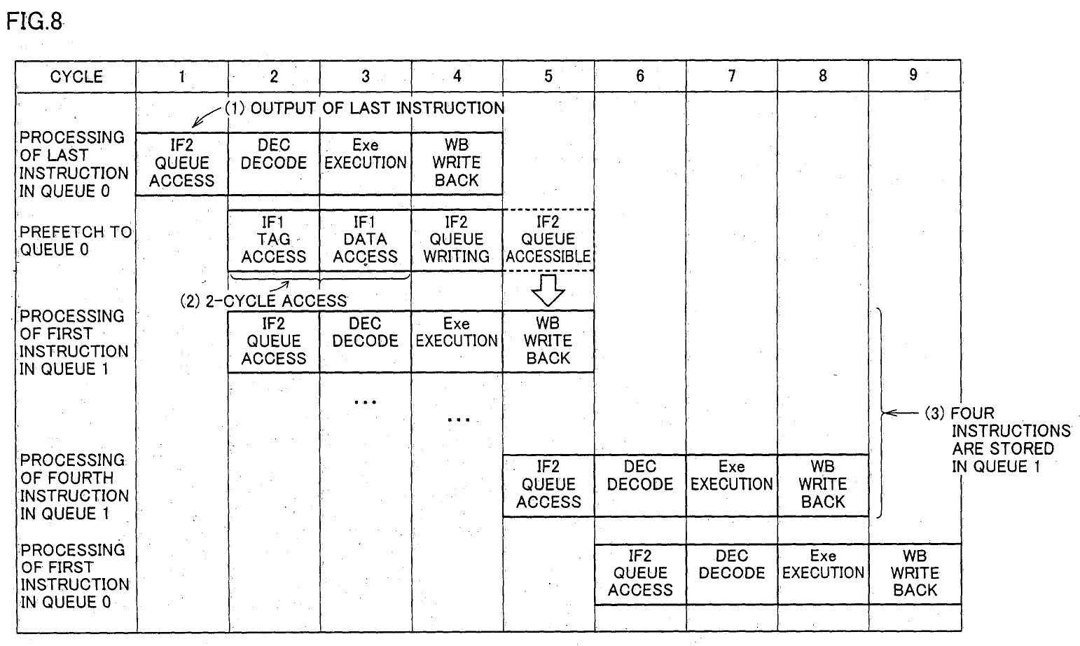

FIG. 8 shows procedure of reading and executing instructions within cache memory 100 in the prefetch operation. Referring to FIG. 8, CPU 120 reads the last instruction within a queue 0, as shown in (1). When the last instruction of queue 0 is output, queue control portion 31 outputs a prefetch request signal to branch/prefetch judgement portion 17. Branch/prefetch judgement portion 17 sets the tag enable signal to an “H” level, and sets the cache access mode switch signal to an “L” level. Thus, cache memory 100 operates in the 2-cycle access mode, as shown in (2), and an instruction is output from cache memory 100 in two cycles.

When the last instruction of queue 0 is output, four instructions in queue 1 are processed sequentially, as shown in (3). The instructions within queue 0 are to be executed after the last instruction within queue 1 is executed. Since four instructions are stored in queue 1, the pipeline stall does not occur even if cache memory 100 operates in the 2-cycle access mode as shown in (2).

As described above, at the time when the CPU performs the pipeline processing on a plurality of instructions, if cache memory 100 operates in the 2-cycle access mode (or even if it operates in the 1-cycle access mode), the pipeline stall will occur after execution of a branch instruction. Thus, according to the cache system of the present embodiment, cache memory 100 is made to operate in the 1-cycle access mode at the relevant time, to reduce the wait time for execution of an instruction.

By comparison, at the occurrence of prefetch, at least three instructions are held in the other queue, which prevents the pipeline stall even if cache memory 100 operates in the 2-cycle access mode. Thus, cache memory 100 is made to operate in the 2-cycle access mode at the relevant time, to realize an operation at low power consumption.

### Second Embodiment

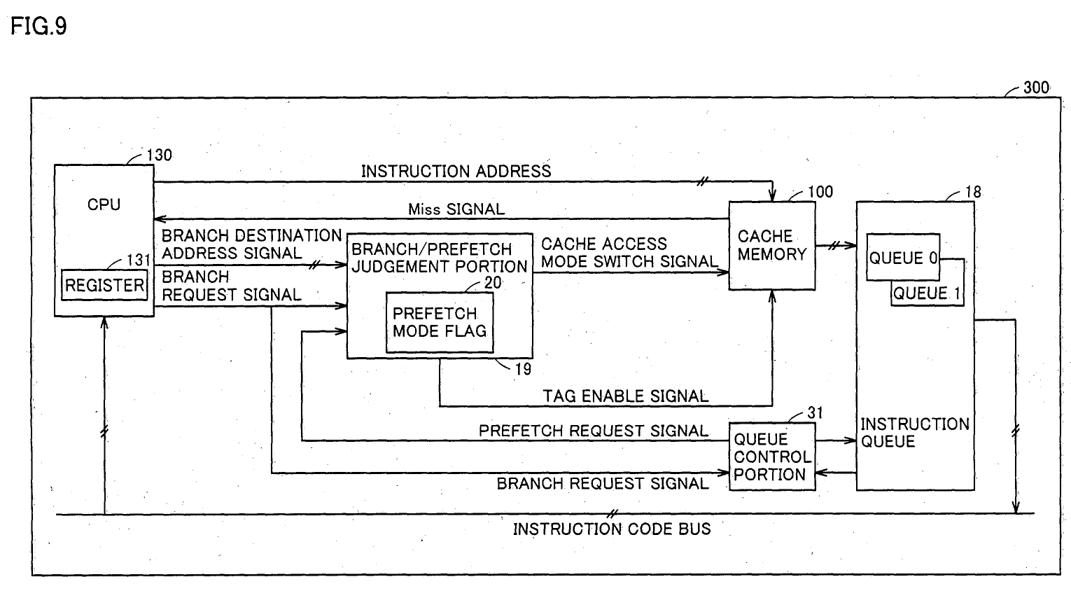

Referring to FIG. 9, the cache system 300 according to the second embodiment of the present invention includes a cache memory 100, a CPU 130, an instruction queue 18, a queue control portion 31, and a branch/prefetch judgement portion 19. The cache system of the present embodiment has portions common to those of the cache system of the first embodiment shown in FIG. 5, which are denoted by the same reference characters, and description thereof is not repeated here.

CPU 130, after execution of a branch instruction, outputs a branch request signal to branch/prefetch judgement portion 19 and to queue control portion 31, and also outputs a branch destination address signal to branch/prefetch judgement portion 19.

Branch/prefetch judgement portion 19, when not receiving a branch request signal or a prefetch request signal, sets the tag enable signal to an “L” level and the cache access mode switch signal to an “L” level. In this case, neither TAG memory 1 nor DATA memory 4 within cache memory 100 operates.

In receipt of the branch request signal, branch/prefetch judgement portion 19 examines the lower two bits of the branch destination address received with the relevant signal, and sets a prefetch mode flag 20 to “H” when they are “HH”. Branch/prefetch judgement portion 19 then sets the tag enable signal to an “H” level and the cache access mode switch signal to an “H” level, as in the first embodiment. In this case, cache memory 100 operates in the 1-cycle access mode, and an instruction is output from cache memory 100 in one cycle.

In receipt of the prefetch request signal, branch/prefetch judgement portion 19 examines the value of the prefetch mode flag.

When the prefetch mode flag is “L” (i.e., a branch instruction is not executed, or even it has been executed, the lower two bits of the branch destination address are not “HH”), branch/prefetch judgement portion 19 sets the tag enable signal to an “H” level and the cache access mode switch signal to an “L” level, as in the first embodiment. In this case, cache memory 100 operates in the 2-cycle access mode, and an instruction is output from cache memory 100 in two cycles.

When the prefetch mode flag is “H” (i.e., the branch instruction has been executed and the lower two bits of the branch destination address are “HH”), branch/prefetch Judgement portion 19 sets the tag enable signal to an “H” level and the cache access mode switch signal to an “H” level. In this case, cache memory 100 operates in the 1-cycle access mode, and an instruction is output from cache memory 100 in one cycle. Cache memory 100 is made to operate in the 1-cycle access mode in the following reason. In the case where the lower two bits of the branch destination address are “HH”, the instruction designated by the branch destination address is the last instruction within a queue. After execution of the relevant instruction, there is no succeeding instruction in the queue. Thus, it is necessary to fetch succeeding instructions from cache memory 100.

Branch/prefetch judgement portion 19, after outputting the cache mode access switch signal, returns the prefetch mode flag to an initial state of “L”.

(Operation When Lower Two Bits of Branch Destination Address Are “HH”)

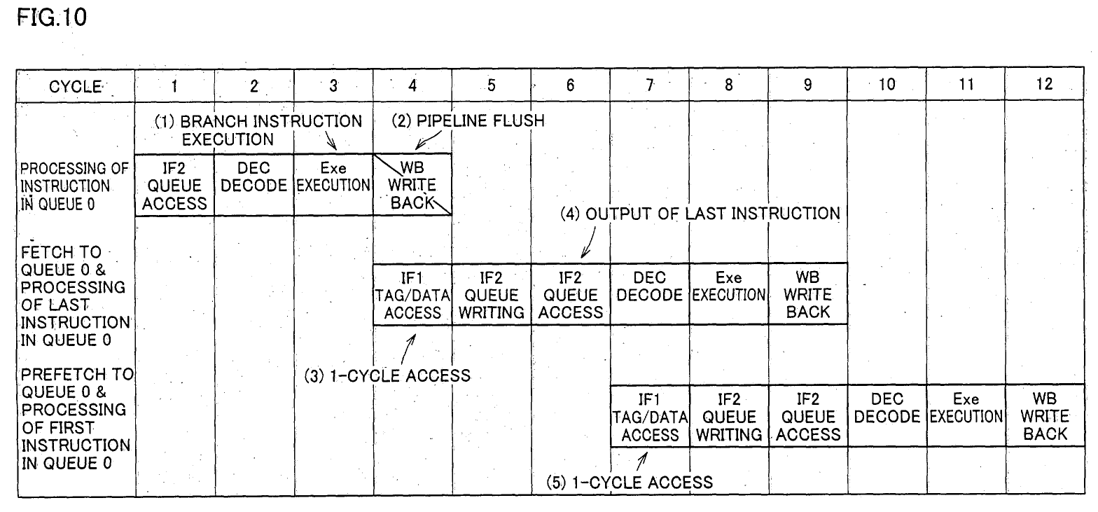

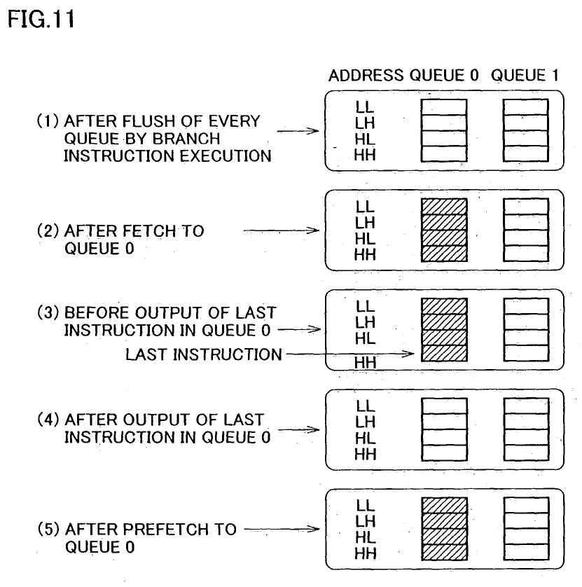

FIG. 10 shows procedure of reading and executing instructions within cache memory 100 when the lower two bits of the branch destination address are “HH”. FIG. 11 shows state transitions of instruction queue 18.

When a branch instruction is executed at CPU 130 as shown in (1) of FIG. 10, the pipeline is flushed as shown in (2) of FIG. 10, and at the same time, instruction queue 18 is flushed. The state of instruction queue 18 at this time is shown in (1) of FIG. 11.

CPU 130 outputs a branch request signal and a branch destination address having its lower two bits being “HH” to branch/prefetch judgement portion 19. Since the lower two bits of the branch destination address are “HH”, branch/prefetch judgement portion 19 sets prefetch mode flag 20 to “H”. Branch/prefetch judgement portion 19 sets the tag enable signal to an “H” level, and sets the cache access mode switch signal to an “H” level. Thus, cache memory 100 operates in the 1-cycle access mode as shown in (3) of FIG. 10, and an instruction is output from cache memory 100 in one cycle. The state of instruction queue 18 at this time is shown in (2) of FIG. 11.

CPU 130 reads the instruction within queue 0 designated by the branch destination address, i.e., the last instruction within queue 0 having the lower two bits of “HH”, as shown in (4) of FIG. 10. The states of instruction queue 18 before and after reading of the last instruction within queue 0 are shown in (3) and (4), respectively, of FIG. 11.

When the last instruction within queue 0 having the lower two bits of “HH” is output, queue control portion 31 outputs a prefetch request signal to branch/prefetch judgement portion 19.

Since the prefetch mode flag is being set to “H”, branch/prefetch judgement portion 19 sets the tag enable signal to an “H” level, and sets the cache access mode switch signal to an “H” level. Thus, cache memory 100 operates in the 1-cycle access mode, as shown in (5) of FIG. 10, and an instruction is output from cache memory 100 in one cycle. The state of instruction queue 18 at this time is shown in (5) of FIG. 11.

As described above, at the time when the CPU performs the pipeline processing of a plurality of instructions, if a branch instruction includes a branch destination address having its lower two bits being “HH”, the instruction designated by the branch destination address is stored as the last instruction within a queue, after execution of the branch instruction. If cache memory 100 is made to operate in the 2-cycle access mode after the relevant instruction of the branch destination address is output from the queue, the pipeline stall will occur. Thus, according to the cache system of the present embodiment, cache memory 100 is made to operate in the 1-cycle access mode at the relevant time, to reduce the wait time for execution of the instruction.

### Third Embodiment

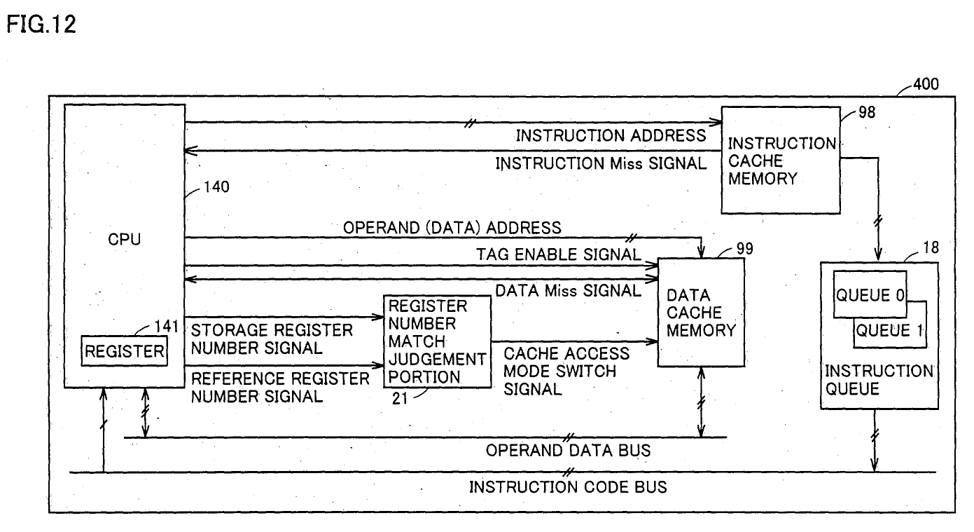

Referring to FIG. 12, the cache system 400 according to the third embodiment of the present invention includes an instruction cache memory 98, a data cache memory 99, a CPU 140, and a register number match judgement portion 21. The cache system of the present embodiment has portions common to those of the cache system of the first embodiment shown in FIG. 5, which are denoted by the same reference characters, and description thereof is not repeated here.

In the present embodiment, the cache memory is divided into the instruction cache memory 98 for storage of instructions, and the data cache memory 99 for storage of data.

When CPU 140 decodes an instruction at the DEC stage, if the instruction is a load instruction for storing data to a register, it outputs a storage register number signal indicating a register number included in the relevant instruction, to register number match judgement portion 21.

When CPU 140 decodes an instruction succeeding (but not necessarily right after) the load instruction at the DEC stage, if the instruction is a reference instruction for referring to data within a register, it outputs a reference register number signal indicating a register number included in the relevant instruction, to register number match judgement portion 21.

When the storage register number received from CPU 140 matches the reference register number, register number match judgement portion 21 sets the cache access mode switch signal to “H”.

When the storage register number and the reference register number mismatch, register number match judgement portion 21 sets the cache access mode switch signal to “L”.

(Operation When Register Numbers Match)

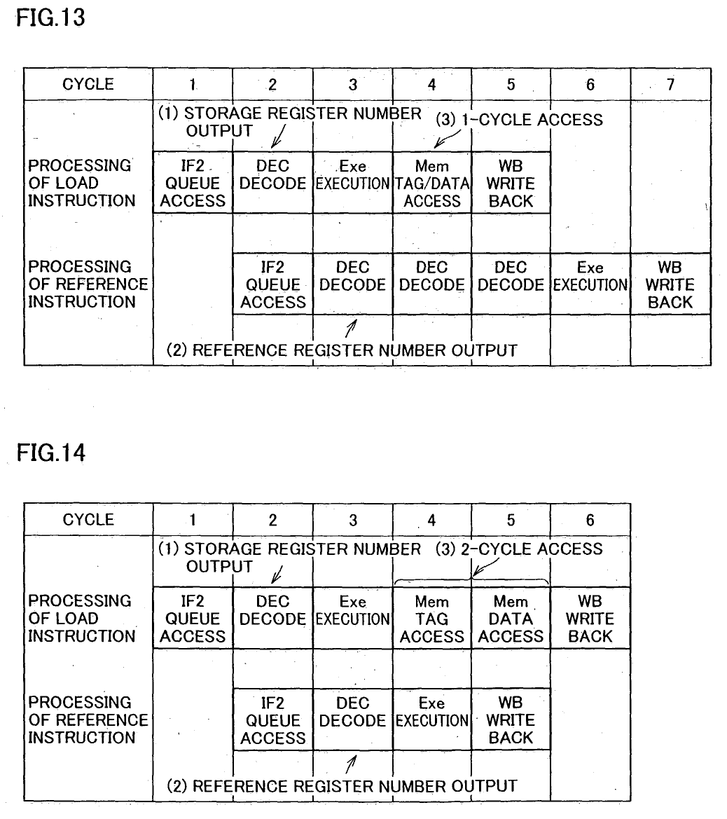

FIG. 13 shows procedure of reading and executing instructions within instruction cache memory 98 and operand data within data cache memory 99 at the time when the register numbers match.

Referring to FIG. 13, firstly, when CPU 140 decodes the load instruction, the storage register number is transmitted to register number match judgement portion 21, as shown in (1). Next, when CPU 140 decodes the reference instruction, the reference register number is transmitted to register number match judgement portion 21, as shown in (2). Since the storage register number and the reference register number match, the cache access mode switch signal of an “H” level is transmitted to data cache memory 99. Data cache memory 99 operates in the 1-cycle access mode, as shown in (3), and thus, operand data is output from data cache memory 99 in one cycle.

(Operation When Register Numbers Mismatch)

FIG. 14 shows procedure of reading and executing instructions within instruction cache memory 98 and operand data within data cache memory 99 at the time when the register numbers mismatch.

Referring to FIG. 14, firstly, when CPU 140 decodes the load instruction, the storage register number is transmitted to register number match judgement portion 21, as shown in (1). Next, when CPU 140 decodes the reference instruction, the reference register number is transmitted to register number match judgement portion 21, as shown in (2). Since the storage register number and the reference register number mismatch, the cache access mode switch signal of an “L” level is transmitted to data cache memory 99. Data cache memory 99 operates in the 2-cycle access mode, as shown in (3), and thus, operand data is output from data cache memory 99 in two cycles.

As described above, in the case where a storage register number included in an instruction for storing data in a register matches a reference register number included in an instruction succeeding the load instruction and for referring to data within a register, the pipeline stall would occur if data cache memory 99 is operated in the 2-cycle operation mode (or even if it is operated in the 1-cycle operation mode). Thus, according to the cache system of the present embodiment, data cache memory 99 is operated in the 1-cycle access mode at the relevant time, to reduce the wait time for execution of the instruction.

By comparison, if the storage register number and the reference register number mismatch, the pipeline stall would not occur even if data cache memory 99 is operated in the 2-cycle access mode. Thus, data cache memory 99 is operated in the 2-cycle access mode, to reduce power consumption during the operation.

### Fourth Embodiment

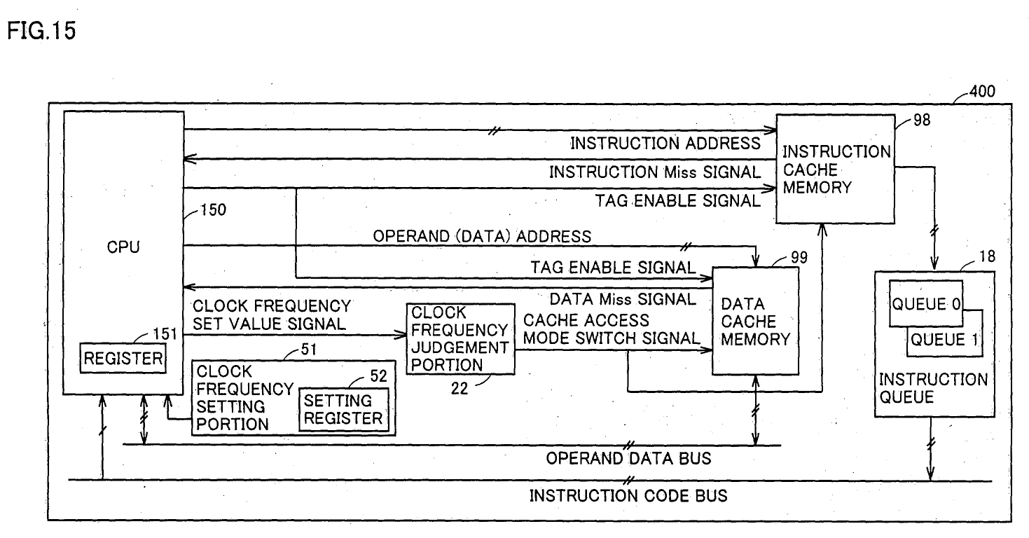

Referring to FIG. 15, the cache system 500 according to the fourth embodiment of the present invention includes a cache memory 100, a CPU 150, a clock frequency setting portion 51, and a clock frequency judgement portion 22. The cache system of the present embodiment has portions common to those of the cache system of the first embodiment shown in FIG. 5, which are denoted by the same reference characters, and detailed description thereof is not repeated.

In the present embodiment, the cache memory is divided into an instruction cache memory 98 for storage of instructions and a data cache memory 99 for storage of data.

Clock frequency setting portion 51 sets a high or low clock frequency to a setting register 52.

CPU 150 has a clock gear function, and operates at a set clock frequency held in setting register 52.

Clock frequency judgement portion 22, when a clock frequency set value signal output from setting register 52 indicates a high clock frequency, sets the cache access mode switch signal to an “H” level. Thus, instruction cache memory 98 and data cache memory 99 operate in the 1-cycle access mode.

When the clock frequency set value signal output from setting register 52 indicates a low clock frequency, clock frequency judgement portion 22 sets the cache access mode switch signal to an “L” level. Thus, instruction cache memory 98 and data cache memory 99 operate in the 2-cycle access mode.

(Operation When Clock Frequency is High)

FIG. 16 shows procedure of reading and executing instructions within instruction cache memory 98 at the time when the CPU operates at a high clock frequency.

Referring to FIG. 16, instruction cache memory 98 operates in the 1-cycle access mode, as shown in (1), and an instruction is output from instruction cache memory 98 in one cycle.

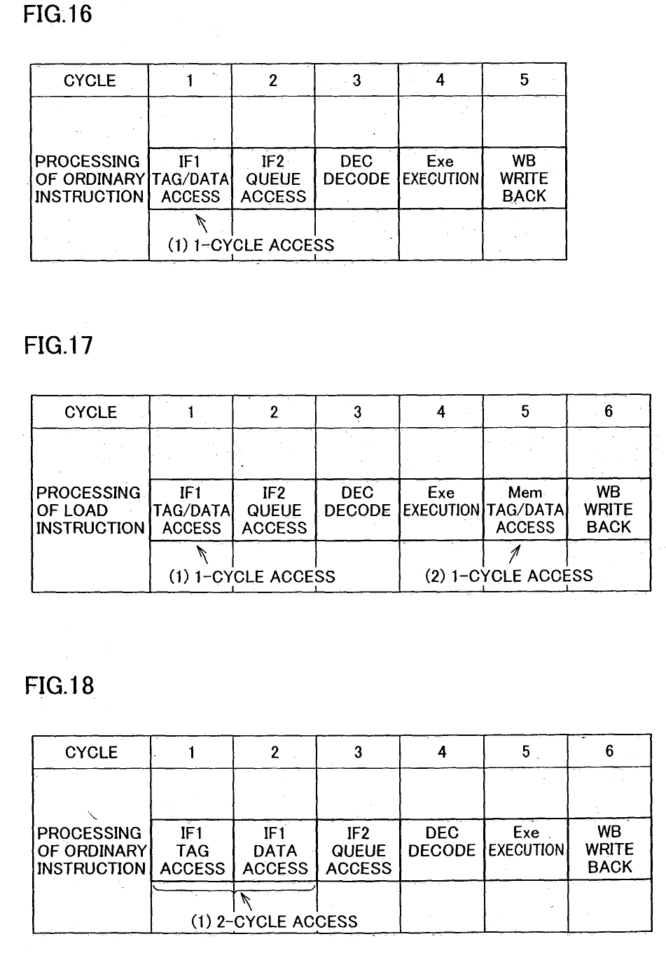

FIG. 17 shows procedure of reading and executing instructions within instruction cache memory 98 and operand data within data cache memory 99 at the time when the CPU operates at a high clock frequency.

Referring to FIG. 17, instruction cache memory 98 operates in the 1-cycle access mode, as shown in (1), and an instruction is output from instruction cache memory 98 in one cycle. Data cache memory 99 operates in the 1-cycle access mode, as shown in (2), and operand data is output from data cache memory 99 in one cycle.

(Operation When Clock Frequency is Low)

FIG. 18 shows procedure of reading and executing instructions within instruction cache memory 98 at the time when the CPU operates at a low clock frequency.

Referring to FIG. 18, instruction cache memory 98 operates in the 2-cycle access mode, as shown in (1), and an instruction is output from instruction cache memory 98 in two cycles.

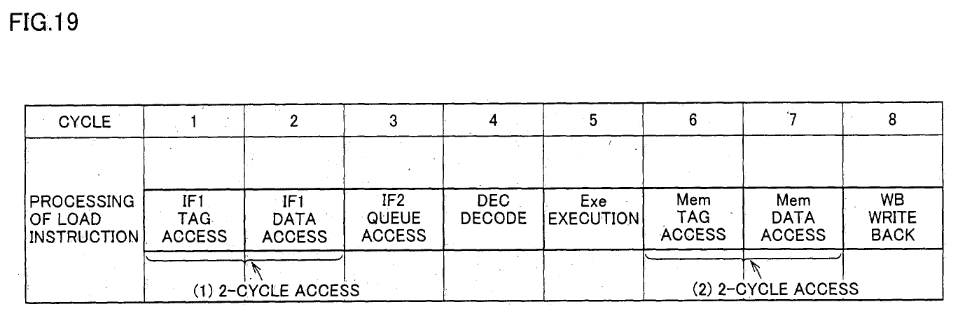

FIG. 19 shows procedure of reading and executing instructions within instruction cache memory 98 and operand data within data cache memory 99 at the time when the CPU operates at a low clock frequency.

Referring to FIG. 19, instruction cache memory 98 operates in the 2-cycle access mode, as shown in (1), and an instruction is output from instruction cache memory 98 in two cycles. Data cache memory 99 operates in the 2-cycle access mode, as shown in (2), and operand data is output from data cache memory 99 in two cycles.

As described above, according to the cache system of the present embodiment, when the CPU operates at a high clock frequency, high-speed data processing is given higher priority than low power consumption. Thus, the 1-cycle access mode is selected to realize the high-speed data processing within the cache memory.

By comparison, when the CPU operates at a low clock frequency, the low power consumption is given higher priority than the high-speed data processing. Thus, the 2-cycle access mode is selected to make the cache memory operate consuming less power.

Modifications

The present invention is not limited to the above-described embodiments, but naturally encompasses the following modifications.

(1) In the third embodiment, a prefetch request signal is generated after the last instruction within queue 0, i.e., the instruction designated by the branch destination address, is output from queue 0, and the prefetch is performed with the signal as a trigger. The present invention is not limited thereto.

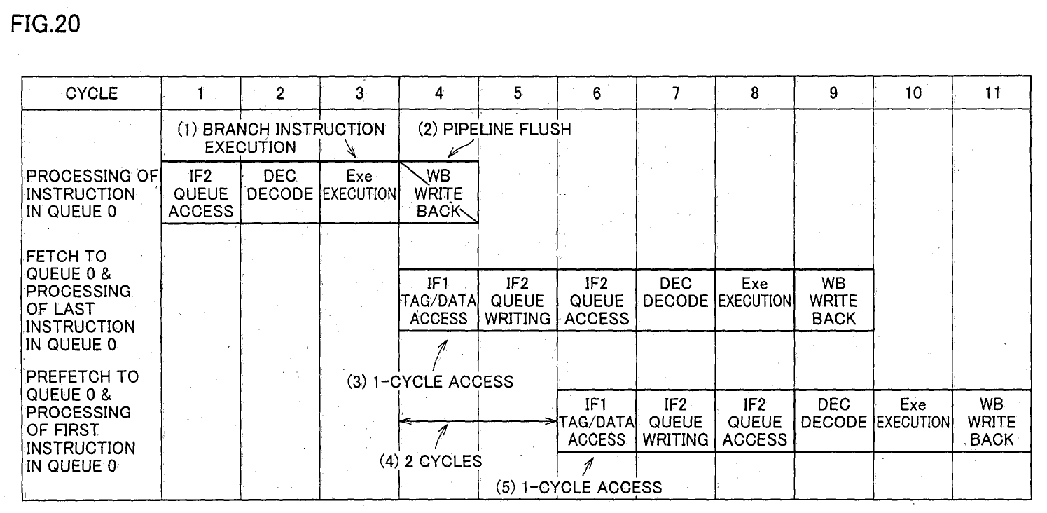

FIG. 20 shows a modification of the procedure of reading and executing instructions within cache memory 100 at the time when the branch destination address has the lower two bits of “HH”.

Referring to FIG. 20, the procedure of processing the branch instruction within queue 0 and the procedure of fetching a plurality of instructions to queue 0 and processing the last instruction within queue 0 being the instruction of the branch destination address, are the same as shown in FIG. 10.

In this modification, with the execution of the branch instruction as a trigger, a prefetch request signal is generated two cycles after the execution cycle of the branch instruction, as shown in (4) of FIG. 20. This is owing to the fact that the stage where the instruction of the branch destination address is read out of queue 0 and the stage where prefetched instructions are written into queue 0 do not overlap, and thus, the instructions would not be lost. As such, it is possible to reduce the wait time for the pipeline processing.

(2) In the third embodiment, at the time when the lower two bits of the branch destination address are “HH”, an instruction succeeding the instruction of the branch destination address is output from the cache memory to queue 0 after the output of the instruction of the branch destination address from queue 0. The invention is not limited thereto.

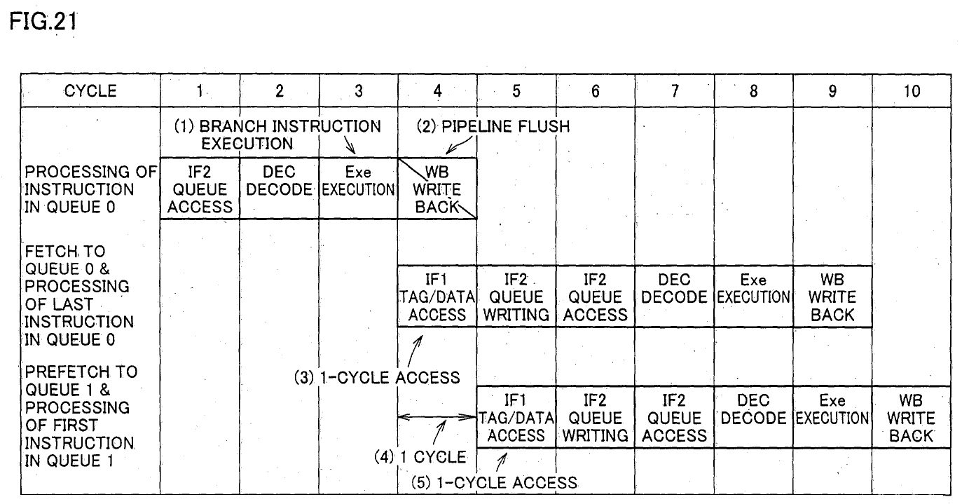

FIG. 21 shows a modification of the procedure of reading and executing instructions within cache memory 100 at the time when the branch destination address has the lower two bits of “HH”.

Referring to FIG. 21, the procedure of processing the branch instruction in queue 0 and the procedure of fetching a plurality of instructions to queue 0 and processing the last instruction within queue 0, i.e., the instruction of the branch destination address, are the same as shown in FIG. 10.

In this modification, as shown in (4) of FIG. 21, with the execution of the branch instruction as a trigger, a prefetch request signal to queue 1 is generated one cycle after the execution cycle of the branch instruction. This is because of the fact that queue 1 is empty as is flushed after execution of the branch instruction, and thus, even if an instruction succeeding the instruction of the branch destination address is output from the cache memory to queue 1, the instruction would not be lost. As such, it is possible to prevent the pipeline stall.

(3) In the fourth embodiment, the CPU is made to operate by switching two kinds of, i.e., high and low, clock frequencies. However, the present invention is not limited thereto. Alternatively, the CPU may be made to operate by switching at least three kinds of clock frequencies. In this case, the cache memory may be configured to operate in the 1-cycle access mode when the CPU operates at a clock frequency of not lower than a prescribed value, and operate in the 2-cycle access mode when the CPU operates at a clock frequency of less than the prescribed value.

For example, assume that the CPU operates by switching three kinds of clock frequencies. In this case, the cache memory may be made to operate in the 1-cycle access mode when the CPU operates at high speed or at medium speed, while it may be made to operate in the 2-cycle access mode when the CPU operates at low speed. Alternatively, the cache memory may be made to operate in the 1-cycle access mode when the CPU operates at high speed, and operate in the 2-cycle access mode when the CPU operates at medium speed or at low speed.

(4) In the embodiments above, instruction queue 18 consists of queue 0 and queue 1. Not limited thereto, it may be configured with at least three queues.

(5) In the embodiments above, the instructions output from the cache memory are stored temporarily in instruction queue 18. However, if prefetch is not to be performed, the instructions output from cache memory 100 may be directly taken into the CPU.

(6) In the first and second embodiments, cache memory 100 outputs four instructions at the same time, and each queue holds at most four instructions. However, the present invention is not limited thereto.

In the first embodiment, cache memory 100 may output three instructions at the same time, and each queue may hold at most three instructions. In this case, again, cache memory 100 can be made to operate in the 1-cycle access mode at the time of prefetch.

Further, in the second embodiment, the cache memory may output at least two instructions simultaneously, and each queue may hold at most two instructions. In this case, it may be configured to determine, when an instruction designated by the branch destination address is stored in a queue, whether it becomes the last instruction or not, based on the value(s) of prescribed bit(s) constituting the branch destination address.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A cache system, comprising:
a cache memory performing an operation to output stored data as accessed, during a first time period in a first access mode, and during a second time period that is longer than the first time period in a second access mode;
a processor performing pipeline processing of the data within said cache memory; and
an access mode control portion outputting to said cache memory one of a first access mode signal designating to operate in said first access mode and a second access mode signal designating to operate in said second access mode, based on presence/absence of pipeline stall in respective one of said access modes.

2. The cache system according to claim 1, wherein
said processor, after execution of a branch instruction, outputs a branch request signal and flushes the pipeline processing for a succeeding instruction, and
said access mode control portion, in receipt of said branch request signal, outputs said first access mode signal.

3. The cache system according to claim 2, comprising:
a plurality of queues holding instructions output from said cache memory; and
a queue control portion outputting a prefetch request signal when a last instruction in respective one of said queues is output;
said cache memory outputting at least three instructions simultaneously to any one of said queues, and
said access mode control portion, in receipt of said prefetch request signal, outputs said second access mode signal.

4. The cache system according to claim 2, comprising:
a plurality of queues holding instructions output from said cache memory; and
a queue control portion outputting a prefetch request signal when a last instruction in respective one of said queues is output;
said cache memory outputting a plurality of instructions simultaneously to any one of said queues,
said processor reading and executing the instructions from said queues, executing the branch instruction, and further outputting a branch destination address,
said access mode control portion, in receipt of the branch destination address, setting a flag in the case where the instruction of the branch destination address when stored in a queue becomes the last instruction in the relevant queue, and
in the case where said flag is set, said access mode control portion, in receipt of a prefetch request signal, outputting said first access mode signal and then canceling said flag.

5. The cache system according to claim 1, wherein
said processor, when decoding an instruction for storing data within a memory in a register, outputs a storage register number included in the relevant instruction,
said processor, when decoding an instruction succeeding said instruction and for referring to data in a register, outputs a reference register number included in the relevant instruction, and
said access mode control portion, in receipt of said storage register number and said reference register number, determines whether said storage register number and said reference register number match or not, and outputs said first access mode signal in the case of a match, and outputs said second access mode signal in the case of a mismatch.

6. The cache system according to claim 1, wherein said cache memory, in said first access mode, causes a plurality of ways to operate simultaneously to output a plurality of data items, and selects and outputs one of said plurality of data items during said first time period, and, in said second access mode, selects and causes one of the plurality of ways to operate to output data during said second time period.

7. A cache memory control device controlling a cache memory performing an operation to output stored data as accessed during a first time period in a first access mode and during a second time period that is longer than the first time period in a second access mode, comprising:
a judgement portion determining whether a processor, processing data within said cache memory by selecting and operating at one of a plurality of clock frequencies, is operating at a clock frequency of not lower than a prescribed value or operating at a clock frequency of less than said prescribed value; and
an access mode control portion outputting a first access mode signal designating said first access mode when said judgement portion determines that said processor is operating at the clock frequency of not lower than said prescribed value, and outputting a second access mode signal designating said second access mode when said judgement portion determines that said processor is operating at the clock frequency of less than said prescribed value.

8. The cache memory control device according to claim 7, wherein said cache memory, in said first access mode, causes a plurality of ways to operate simultaneously to output a plurality of data items and selects and outputs one of said plurality of data items during said first time period, and, in said second access mode, selects and causes one of the plurality of ways to operate to output data during said second time period.
